(19) United States
(12) Patent Application Publication
(10) Pub. No.: US 2021/0368262 A1
(43) Pub. Date: Nov. 25, 2021

(54) USE MODE-BASED MICROPHONE PROCESSING APPLICATION MODIFICATIONS

(71) Applicant: HEWLETT-PACKARD DEVELOPMENT COMPANY, L.P., SPRING, TX (US)

(72) Inventor: LEE ATKINSON, TAIPEI CITY (TW)

(21) Appl. No.: 16/763,478

(22) PCT Filed: Mar. 5, 2018
(86) PCT No.: PCT/US2018/020828

§ 371 Date: May 12, 2020

(51) Int. Cl. H04R 1/40; G10L 15/22

(52) U.S. Cl. CPC H04R 1/406; G10L 2015/223; G10L 15/22

(57) ABSTRACT

An example electronic device is described, which may include a microphone, a sensor, a detection unit, and a control unit. The detection unit may detect a use mode of the electronic device via the sensor. The use mode may be determined based on an operation mode associated with the microphone. Further, the control unit may modify a microphone processing application based on the detected use mode.

### BACKGROUND

The emergence and popularity of mobile computing has made portable electronic devices, due to their compact design and light weight, a staple in today's marketplace. Within the mobile computing realm, electronic devices such as notebook computers, laptops, and the like may be widely used and may employ a clamshell-type design with two housings connected at a common end via a hinge assembly. For example, a first or display housing is utilized to provide a viewable display while a second or base housing includes an area for user input (e.g., a touchpad and a keyboard). Such devices can be used in a clamshell mode, a tablet mode, a tent mode, and the like. In other examples, the first and second housings can be detachably coupled. Further, the electronic devices may be equipped with a microphone or an array of microphones to detect voice activity of a user.

### BRIEF DESCRIPTION OF THE DRAWINGS

Examples are described in the following detailed description and in reference to the drawings, in which:

FIG. 1 is a block diagram of an example electronic device, including a control unit to modify a microphone processing application based on a use mode;

FIG. 2 is a schematic representation of an example electronic device, depicting a control unit to modify a microphone processing application based on an orientation of a first housing relative to a second housing;

FIG. 3 is a block diagram of an example electronic device for controlling a microphone processing application based on a use mode; and

FIG. 4 is a block diagram of an example electronic device including a non-transitory computer-readable storage medium, storing instructions to control a microphone processing application.

### DETAILED DESCRIPTION

Electronic devices may include a microphone or an array of microphones to detect voice signals (e.g., voice commands). Further, electronic devices may include a microphone processing application to process the voice signals. The microphone array may use multiple microphones and the microphone processing application may improve a signal-to-noise ratio to a sound application. Example microphone processing application for noise reduction may include a beamforming, blind signal separation (BSS), and the like.

Some microphone processing applications may anticipate user's orientation to the electronic device, for instance, by creating either a planar or conical directional path that may reject off-axis noise and prioritizing a speaker position directly in front of a display screen. However, in a “clamshell-closed” or a “bag” mode, the physical relationship between the user and the electronic device may not be determined by a viewing angle of the display screen.

Some microphone processing applications may operate by comparing a received input signal from a differential microphone array to correlate or compare differences in detecting the voice signals. For example, beamforming may compare a phase of the microphones to spatially locate a position of a user operating the electronic device and then apply adaptive filtering to remove audio content that may not be similarly received by the other microphone. Beamforming may be effective when the speaker's position is directly perpendicular to a center of the microphone array. The position of the microphone array may correspond to an expected viewing angle of the display screen and the position of the user interface (e.g., a keyboard, touchscreen, touchpad, and the like). However, a display screen having the microphones in a linear array along the horizontal bezel, when coupled with the beamforming application may reject voice commands outside a vertical plane created by the array as noise.

Such microphone processing applications may not detect voice commands when the user is not directly in front of the electronic device (i.e., an open display unit or keyboard unit). For example, microphone processing applications may not detect voice commands when the lid is closed (e.g., microphones may be physically impaired due to diminution by the closure of the lid on a clamshell device or a cover/bag that can impair the ability of the microphones to equally sense the voice commands). Since, some microphone processing applications operate by correlating different microphones, affecting a single microphone may lead to an un-impaired microphone signal being distorted by the microphone processing application. Further in tablet mode, 360° form factor means that the microphone operation may reject voice commands coming from the keyboard side of the electronic device.

Examples described herein may enhance voice recognition in electronic devices, particularly, in a clamshell-closed mode, a tablet mode, a tent mode, or a bag mode with the microphone being operated in an always-listening mode. Examples described herein may enhance voice recognition in electronic devices during a physical impediment associated with the microphone (e.g., a clamshell-closed mode, a bag mode, an object over the microphone, or the like).

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

Examples described herein may provide an electronic device including a microphone, a sensor, a detection unit, and a control unit. During operation, the detection unit may detect a use mode of the electronic device via the sensor. The use mode may be determined based on an operation mode associated with the microphone. Further, the control unit may modify a microphone processing application based on the detected use mode.

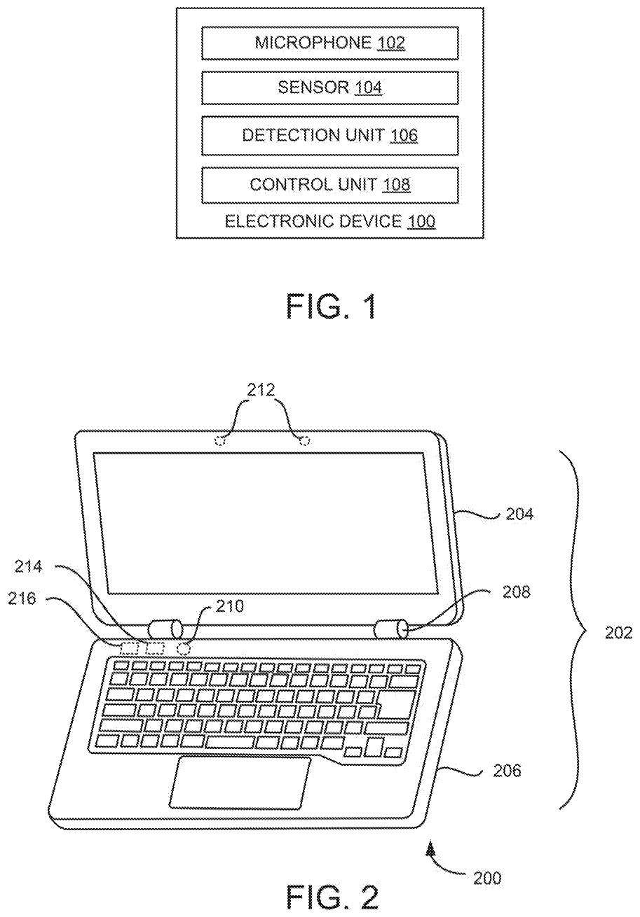

Turning now to the figures, FIG. 1 illustrates a block diagram of an example electronic device 100, including a control unit 108 to modify a microphone processing application based on a use mode. Example electronic device 100 may include a notebook, tablet, personal computer (PC), smart phone, gaming laptop, workstation, and the like.

Electronic device 100 may include a microphone 102, a sensor 104, a detection unit 106, and control unit 108. In one example, microphone 102 may operate in an always-listening mode that awaits a voice command. Example voice command may include a predefined command (e.g., “awake,” “sleep” and the like), or a casual command (e.g., “What is the temperature outside?”). In other examples, the vocal input may represent an operational request or command. The request may be for any type of operation, such as database inquiries, requesting and consuming entertainment (e.g., gaming, finding and playing music, movies, or other content), personal management (e.g., calendaring, note taking, and the like), online shopping, financial transactions, and other operations.

Example sensor 104 may be selected from a group consisting of a camera, an accelerometer, a lid positional sensor, a device orientation sensor, a contact sensor (e.g., a capacitive sensor or a resistive sensor), a hall effect sensor, and a motion sensor (e.g., a proximity sensor). In one example, the components of electronic device 100 may be implemented in hardware, machine-readable instructions or a combination thereof. In one example, detection unit 106 and control unit 108 may be implemented as engines or modules comprising any combination of hardware and programming to implement the functionalities described herein.

During operation, detection unit 106 may detect a use mode of electronic device 100 via sensor 104. In one example, the use mode may be determined based on an operation mode associated with microphone 102. Example operation mode may correspond to a clamshell-closed mode, a tablet mode, a tent mode, or a bag mode. In other examples, the operation mode may be determined based on a direction of a voice command received by microphone 102.

For example, electronic device 100 may include a first housing including a display screen and a second housing including a keyboard that is pivotally connected to the first housing. The term “clamshell-closed mode” may refer to a configuration in which the display screen is facing the keyboard and the two are parallel. The term “tent mode” may refer to a configuration in which the display screen is facing the user in landscape or inverted landscape orientation and is more than 180° open from the clamshell-closed state but may not be fully in the tablet (360°) mode. The term “tablet mode” may refer to a configuration in which the display screen is facing the user in landscape, portrait, inverted landscape, or inverted portrait orientation. In the tablet mode, the keyboard is facing in the opposite direction from the display screen and the two are parallel. The term “bag mode” may refer to a mode in which electronic device 100 may be placed in a bag. In the clamshell-closed mode, tablet mode, tent mode, or bag mode, a microphone processing application may be affected, for instance, due to a physical impediment affecting an operation of microphone 102 or a direction of a voice command received by microphone 102 (e.g., the speaker's position may not be directly perpendicular to a center of microphone 102).

In one example, control unit 108 may modify a microphone processing application based on the detected use mode. For example, control unit 108 may disable the microphone processing application based on the detected use mode. For example, in a “clamshell open” mode, where the display screen and the keyboard are not parallel and are available for user access, sensor 104 (e.g., a lid sensor) may detect that the lid is open and control unit 108 may enable to use a differential microphone application (e.g., a beamforming application). However, in the “clamshell closed” mode, sensor 104 may detect that the lid is closed, which can affect a microphone (e.g., microphone 102) in a microphone array disposed in a bezel of electronic device 100. In this example, control unit 108 may disable the differential microphone application. In other words, control unit 108 may modify the differential microphone application to operate in a non-differential operation in the “clamshell closed” mode.

FIG. 2 illustrates a schematic representation of an example electronic device 200, depicting a control unit 216 to modify a microphone processing application based on an orientation of a first housing 204 relative to a second housing 206. Example electronic device 200 may be a notebook computer, a tablet computer, a convertible device, a personal gaming device, and the like. Example convertible device may refer to a device that can be “convertible” from a laptop mode to a tablet mode or a tent mode.

Electronic device 200 may include a device housing 202. Device housing 202 may include first housing 204, second housing 206, and a hinge assembly 208 to pivotally connect first housing 204 and second housing 206. Example first housing 204 may be a display housing and second housing 206 may be a base housing. In one example, first housing 204 may be rotatably, detachably, or twistably, connected to second housing 206. The display housing may house a display (e.g., a touchscreen display). Example display may include liquid crystal display (LCD), light emitting diode (LED) display, electro-luminescent (EL) display, or the like. The base housing may house a keyboard, touchpad, battery, and the like. Electronic device 200 may also be equipped with other components such as a camera, audio/video devices, and the like, depending on the functions of electronic device 200.

Further, device housing may include a sensor 210, a microphone array 212, a detection unit 214, and control unit 216 disposed therein. In one example, sensor 210, microphone array 212, detection unit 214, and control unit 216 may be disposed in first housing 204, second housing 206, or any combination thereof. In the example shown in FIG. 2, microphone array 212 may be disposed along a horizontal bezel in first housing 204 and sensor 210, detection unit 214, and control unit 216 may be disposed in second housing 206.

During operation, detection unit 214 may detect, via sensor 210, a use mode of electronic device 200. The use mode may be determined based on an orientation of first housing 204 relative to second housing 206. Example use mode may correspond to a clamshell-closed mode, a tablet mode, or a tent mode. For example, electronic device 200 may be operated in different orientations which can affect the microphone processing application that can be applied to reduce noise in the detected audio signal. For example, in a tablet mode or a tent mode, microphone may receive the voice commands from an opposite side. In this example, microphone processing application may reject the voice commands received from the opposite side, thereby affecting an operation of electronic device 200.

In one example, control unit 216 may modify the microphone processing application based on the detected use mode to enhance voice recognition. Example microphone processing application may be a noise-reduction application such as an echo cancellation, dereverberation, beamforming, blind source separation, noise cancellation, spectral shaping, or any combination thereof. In one example, control unit 216 may modify processing of an audio signal from microphone array 212 to produce an output signal based on the detected use mode.

For example, converting between the modes may involve flipping or twisting the display screen so that the display screen folds down on top of or behind the keyboard. In the tablet mode or tent mode, a position of microphone array 212 can be changed, which may affect the microphone processing application. For instance, beamforming may get affected in the tablet mode or tent mode as the beamforming may be used with microphone array 212 for directional signal reception and reject off-axis noise.

In this example, when electronic device 200 is detected to be in the tent mode, control unit 216 may modify the microphone processing application (e.g., beamforming) to enhance the received audio input. In the example of the tent mode, control unit 216 may disable the beamforming as the beamforming may reject voice commands from the opposite side. Thus, examples described herein may enhance the audio input (e.g., a microphone input) when electronic device 200 is operated in other modes, such as the tent mode, clamshell-closed mode, tablet mode, or bag mode. Examples described herein may be applied to convertible device or to a non-convertible device, such as tablets, bar-type phones, flip phones, smart phones, clamshell style laptops, e-readers, and the like.

In one example, the components of electronic device 200 may be implemented in hardware, machine-readable instructions, or a combination thereof. In one example, detection unit 214 and control unit 216 may be implemented as engines or modules comprising any combination of hardware and programming to implement the functionalities described herein.

Electronic device (e.g., electronic device 100 or 200 of FIG. 1 or FIG. 2, respectively) may include computer-readable storage medium comprising (e.g., encoded with) instructions executable by a processor to implement functionalities described herein in relation to FIGS. 1-2. In some examples, the functionalities described herein, in relation to instructions to implement functions of components of electronic device 100 or 200 and any additional instructions described herein in relation to the storage medium, may be implemented as engines or modules comprising any combination of hardware and programming to implement the functionalities of the modules or engines described herein. The functions of components of electronic device 100 or 200 may also be implemented by a respective processor. In examples described herein, the processor may include, for example, one processor or multiple processors included in a single device or distributed across multiple devices.

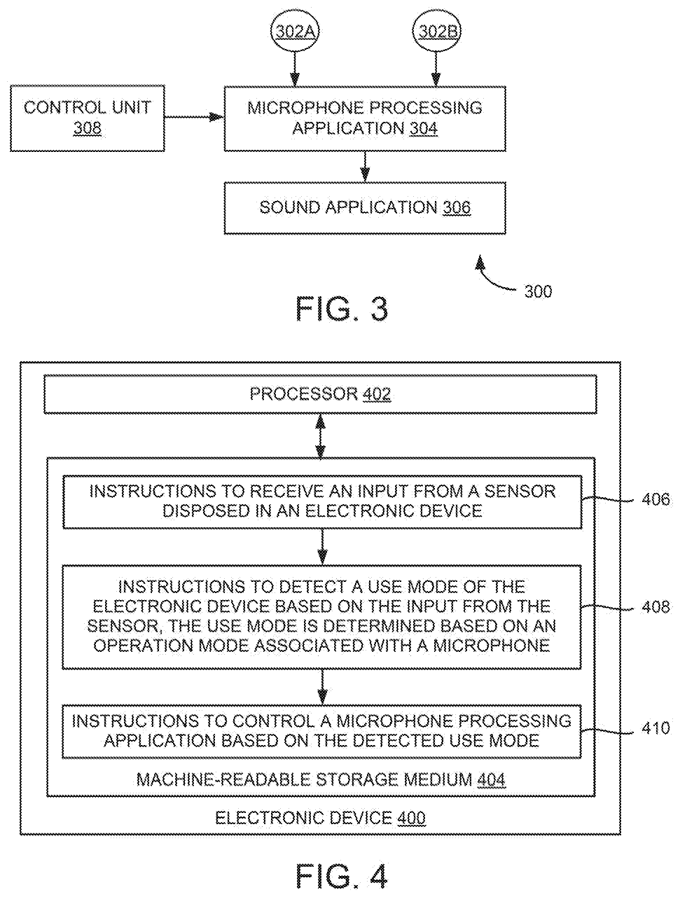

FIG. 3 illustrates a block diagram of an example electronic device 300 for controlling a microphone processing application 304 based on a use mode. In one example, microphones 302A and 302B associated with electronic device 300 may detect an audio signal (e.g., a voice activity/command), for instance, from a user. Further, a use mode of electronic device 300 may be detected (e.g., using detection unit 106 of FIG. 1 or 214 of FIG. 2). Furthermore, control unit 308 may modify microphone processing application 304 to process the audio signal from microphones 302A and 302B and produce an audio output signal based on the detected use mode. Further, the processed audio signals may be outputted to a sound application 306.

FIG. 4 illustrates a block diagram of an example electronic device 400 including a non-transitory machine-readable storage medium 404, storing instructions to control a microphone processing application. Electronic device 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to electronic device 400.

Machine-readable storage medium 404 may store instructions 406-410. In an example, instructions 406-410 may be executed by processor 402 to control microphone processing application based on a use mode of electronic device 400. Instructions 406 may be executed by processor 402 to receive an input from a sensor disposed in electronic device 400.

Instructions 408 may be executed by processor 402 to detect a use mode of electronic device 400 based on the input from the sensor. The use mode may be determined based on an operation mode associated with a microphone. In one example, the operation mode may be determined based on a first housing orientation relative to a second housing orientation of the electronic device. In another example, the operation mode may correspond to a clamshell-closed mode, a tablet mode, a tent mode, or a bag mode. In yet another example, the operation mode may correspond to a physical impediment associated with the microphone, such as an object over the microphone which can affect the operation of the microphone. In yet another example, the operation mode may correspond to an impairment of a microphone in an array to substantially simultaneously detect an audio signal.

Instructions 410 may be executed by processor 402 to control a microphone processing application based on the detected use mode. In one example, controlling the microphone processing application may include modifying processing of an audio signal from the microphone to produce an output signal based on the detected use mode.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An electronic device comprising:
a microphone;
a sensor;
a detection unit to detect a use mode of the electronic device via the sensor, wherein the use mode is determined based on an operation mode associated with the microphone; and
a control unit to modify a microphone processing application based on the detected use mode.

2. The electronic device of claim 1, wherein the operation mode corresponds to a clamshell-closed mode, a tablet mode, a tent mode, or a bag mode.

3. The electronic device of claim 1, wherein the operation mode is determined based on a direction of a voice command received by the microphone.

4. The electronic device of claim 1, wherein the sensor is selected from a group consisting of a camera, an accelerometer, a lid positional sensor, a device orientation sensor, a contact sensor, a hall effect sensor, and a motion sensor.

5. The electronic device of claim 1, wherein the microphone is to operate in an always-listening mode.

6. An electronic device comprising:
a device housing comprising:
a first housing;
a second housing; and
a hinge assembly to pivotally connect the first housing and the second housing;
a sensor disposed within the device housing;
a microphone array disposed within the device housing;
a detection unit disposed within the device housing to detect, via the sensor, a use mode of the electronic device, wherein the use mode is determined based on an orientation of the first housing relative to the second housing; and
a control unit to modify a microphone processing application based on the detected use mode.

7. The electronic device of claim 6, wherein the control unit is to modify processing of an audio signal from the microphone array to produce an output signal based on the detected use mode.

8. The electronic device of claim 6, wherein the use mode corresponds to a clamshell-closed mode, a tablet mode, or a tent mode.

9. The electronic device of claim 6, wherein the microphone processing application comprises a noise-reduction application, and wherein the noise-reduction application comprises an echo cancellation, dereverberation, beamforming, blind source separation, noise cancellation, spectral shaping, or any combination thereof.

10. A non-transitory machine-readable storage medium encoded with instructions that, when executed by a processor, cause the processor to:
receive an input from a sensor disposed in an electronic device;
detect a use mode of the electronic device based on the input from the sensor, wherein the use mode is determined based on an operation mode associated with a microphone; and
control a microphone processing application based on the detected use mode.

11. The non-transitory machine-readable storage medium of claim 10, wherein instructions to control the microphone processing application comprises:
instructions to modify processing of an audio signal from the microphone to produce an output signal based on the detected use mode.

12. The non-transitory machine-readable storage medium of claim 10, wherein the operation mode is determined based on a first housing orientation relative to a second housing orientation of the electronic device.

13. The non-transitory machine-readable storage medium of claim 10, wherein the operation mode corresponds to a clamshell-closed mode, a tablet mode, a tent mode, or a bag mode.

14. The non-transitory machine-readable storage medium of claim 10, wherein the operation mode corresponds to a physical impediment associated with the microphone.

15. The non-transitory machine-readable storage medium of claim 10, wherein the operation mode corresponds to an impairment of the microphone.
